(19) United States
(12) Patent Application Publication
(10) Pub. No.: US 2010/0062186 A1
(43) Pub. Date: Mar. 11, 2010

(54) Ultra-thin polymeric membrane

(76) Inventors: Dennis G. Peiffer, Annandale, NJ (US); Randall D. Partridge, Califon, NJ (US); Walter Weissman, Basking Ridge, NJ (US); David C. Dalrymple, Bloomsbury, NJ (US)

Correspondence Address: EXXONMOBIL RESEARCH AND ENGINNEERING COMPANY, P.O. Box 900, Annandale, NJ, 08801-0900, US

(21) Appl. No.: 12/456,800

(22) Filed: Jun. 23, 2009

Related U.S. Application Data
(60) Provisional application No. 61/191,621, filed on Sep. 10, 2008.

(51) Int. Cl. B05D 1/18; B05D 3/02

(52) U.S. Cl. 427/601; 427/385.5; 427/386; 427/294

(57) ABSTRACT

A ultra-thin polymeric membrane is made by coating a porous substrate, such as a ceramic monolith, with a solution of a polymer colloid, then drying the solution to form the film. The polymer is an associating polymer. The resulting membrane may be used for separating hydrocarbon species, for example.

This application claims the benefit of U.S. Provisional Application No. 61/191,621 filed Sep. 10, 2008.

### BACKGROUND OF THE INVENTION

The present invention generally relates to polymeric membranes and particularly to a process to uniformly coat a porous substrate such as a ceramic monolith using an associating polymer formulation that facilitates coating exceptionally thin membranes onto the porous substrate.

Membranes serve a wide variety of separations purposes. They typically provide a semi-porous medium for species separations. In fuel cells, for example, membranes are used to preferentially permit the transport of protons over electrons. Membranes may achieve their separations function by physical, geometric means (e.g. a molecular sieve) or chemical means (e.g. a pervaporation membrane). The process of the present invention is exemplified herein in producing ultra-thin membrane that are intended for use as pervaporation membranes, but may be suitable for use in preparing ultra-thin membranes having other transport/separations functions (eg. Gas separations). Membranes have long held out a promise to reduce the costs and resources used to “refine” petroleum products. For example, aromatics may be separated from gasoline by pervaporation to obtain higher-octane fuel. Asphaltenes and metals may be separated from crude as a refining pretreatment step. A common deficiency in membrane system efficiency has traditionally been the “trade-off” between membrane selectivity and flux. Ultra-thin, high flux membrane films of a composition showing high species selectivity is the goal for an efficient membrane, a goal yet to be achieved prior to this invention.

If successful, such membranes could supplant costly, energy intensive refining processes presently used.

If successful such membranes could supplant costly, energy intensive separation processes in Upstream, Downstream and Chemical-based operations.

This invention is directed to a new process to make copolymer membranes that evidences an ability to uniformly coat a porous substrate such as a ceramic monolith surface with a very thin polymeric membrane. The membrane is based on the use of associating polymer formulations, including polyamic acid polymers, that facilitate coating exceptionally thin membranes onto porous substrates. The resulting membrane provides substantial separations performance gains using substantially less polymeric material than in more conventional approaches for membrane formation. The method employs a specific amount of a nonsolvent or nonsolvent mixtures (or a poor solvent or a mixture of poor solvents or poor solvent/nonsolvent mixtures) to produce a stable solution of a polymer colloid which can be used to coat a ceramic substrate with a ultra-thin polymer membrane.

The present invention enables a polymeric film having both high flux and selectivity, required for increased efficiency to enable commercialization of this application.

### SUMMARY OF THE INVENTION

The present invention comprises a new process for forming a copolymer membrane from a colloidal solution of at least one associating polymer to uniformly coat a porous substrate surface. The process uses a stable polymer colloid solution having a polymer concentration of about C* (i.e., critical chain overlap concentration) and including an amount of non-solvent. The colloidal solution is coated onto the surface of a porous substrate to form an ultra-thin polymeric membrane, useful for hydrocarbons separating. Optionally ultrasonic vibration can be applied to the coating solution, the substrate surface, or both, to help insure a uniform, defect-free and bubble-free coating on the membrane support, e.g., ceramic monolith surface. In addition, subsequent membrane thickening may be achieved via applying a slip coat or multi-slip coats. The membrane coated substrate is dried and subsequently cured at elevated temperatures.

### BRIEF DESCRIPTION OF THE DRAWINGS

FIG. 1 illustrates a simple embodiment of the membrane of the present invention.

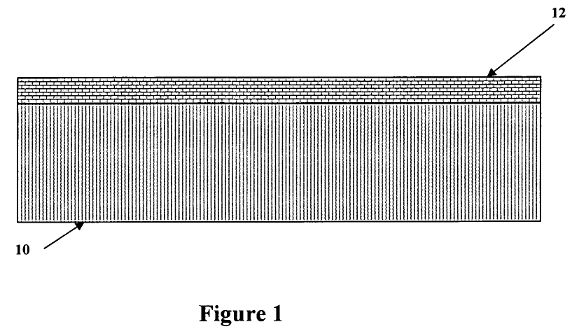

### DETAILED DESCRIPTION OF THE PREFERRED EMBODIMENTS

The present invention is directed to an improved process for making ultra-thin polymeric membranes. The membrane is formed by first coating a porous substrate with a polymer colloid solution. In a preferred embodiment, the porous substrate comprises a ceramic monolith which is coated with the polymer solution through the use of a vacuum, used to draw the polymer solution onto the coating surface. During the coating process an ultrasonic vibration can optionally be applied to insure a uniform distribution of the polymer solution onto the ceramic support surface. Optional subsequent membrane thickening may be achieved by applying a slip coat or multi-slip coats. The membrane coated monolith is dried and cured at elevated temperatures. In a preferred embodiment, the membrane is a polyimide copolymer. The composition of the polyimide layer preferably incorporates a hard/stiff segment, having a glass transition temperature greater than approximately 100° C. and a lower modulus/elastomeric segment having a glass transition temperature less than approximately 100° C. These hard and soft segments are preferably formed in an alternating, multi-block structure. In particular, the copolymer composition contains an imide-based hard segment and a soft segment containing an aliphatic polyester. For example, the polyimide segment contains pyromellitic dianhydride (PMDA) and 4,4′-methylene bis(2-chloroaniline) [MOCA], [or 4-aminophenyl disulfide (APD) segments], i.e., a dianhydride and a diamine, respectively. The soft segment may be a polyadipate, a polysuccinate, a polymalonate, a polyoxalate, a polyglutarate or a combination thereof. Another aspect of this invention is the use of various mixtures of diamines and dianhydrides. These latter compounds are known to those versed in the state of the art and exemplified in U.S. Pat. Nos. 4,990,275 and 5,670,052. Another novel aspect of this invention is the use of the polyamic acid form of the polyimide to solution coat the above described substrates.

The present invention uses associating-type polymers to form the membranes. The associating functionalities greatly facilitate deposition of the membrane material. The practice of the present invention prefers, but is not limited to, the use of polyamic acid-type associating polymers. The term “associating polymer”, as used herein, means polymers that include functionalities possessing hydrogen-bonding interactions (e.g., polyamic acids), polar interactions, dipolar interactions, hydrophobic, ionic interactions and stereoregular interactions and their combinations. Membrane formation, performance, and utility are directly related to the structural components comprising the copolymer structure. Another novel aspect of this invention is that various combinations of diamines, dianhydrides and difunctional soft segments can be incorporated into the copolymer structure to form a wide variety of multi-compositional polyamic acids that can be coated, dried and cured on the surface of the substrate. Another novel aspect of this invention is that various random monomer structures and diblock, triblock, and multiblock combinations of monomers segments can be incorporated into the copolymer structure to form a wide variety of compositions and monomer combinations that can be coated, dried and cured on the surface of the substrate. Another novel aspect of this invention is the ability to effectively and efficiently coat the inner (and outer surfaces) of porous inorganic (and organic) tubular or channeled substrates. The processes taught herein lend themselves to highly automated manufacture with excellent quality control.

### The Substrate

Referring to the FIGURE, layer 10 comprises a porous substrate. Though illustrated as flat, the substrate may include many alternate configurations such as cylindrical, honeycomb, or others, known to the skilled membrane practitioner. The substrate preferably comprises an inorganic porous substrate, more particularly a porous ceramic substrate. The degree of porosity may vary, but generally the pore sizes should range from about 0.01 microns to about 100 microns, preferably from about 0.1 microns to about 10 microns. One aspect of the present invention is the ability to form a uniform, ultra-thin polymeric membrane, ranging in thickness from about 0.005 microns to about 100 microns, preferably from about 0.01 microns to about 10 microns on substrates having the above described surface porosity characteristics. The substrate may comprise multiple layers, or may have a bulk composition with a surface layer, such as that substrates exemplified hereinafter. Suitable membrane inorganic materials include alumina, silica, titania, or combinations thereof.

### The Polymer Coating Process

First, a solution of the intended associating copolymer is made at or about c*, the critical chain overlap concentration of the copolymer. To this solution is added an amount of non-solvent or a combination of non-solvent and “poor” solvent is added. The term non-solvent herein means the polymeric material has no solubility in this particular fluid system. The term poor solvent herein means the polymeric material has limited solubility in this particular fluid system. The amount of non-solvent may range from about 1% to about 50%, preferably from about 5% to about 30%. The specific concentration of non-solvent or poor solvent is dependent on the polymer concentration, polymer molecular weight, and polymer composition. The addition of the foregoing non-solvent or non-solvent with poor solvent produces a colloidal suspension of the co-polymer. Typically, the colloidal suspension evidences a bluish tint or a milky white appearance. Typically, the colloidal suspension can have a viscosity from about 1 centipoise to about 100 centipoise. The application of the product to the substrate surface can be also performed via flowing the product over the support surface with or without a vacuum assist, dip coating, mechanical application such as a doctor blade and the like. In addition, membrane wetting of the substrate as well as any associated air bubbles can be eliminated during membrane preparation, optionally via the application of ultrasonic vibration. It is noteworthy that the ultrasonic vibrations do not damage the membrane nor the brittle ceramic support surface. Even further enhancements are produced via pre-shearing and/or aging of the associating copolymer solution at/above/below room temperature. The performance of the membrane coating can be further enhanced via addition of a secondary slip coat or multiple slip coats of the original polyamic acid solution (i.e., solution without the non-solvent).

By adjusting the concentration of the associating polyamic acid copolymer to a range of greater than about fifty percent (50%) of its c* concentration (i.e., critical chain overlap concentration) to about two hundred percent 200%) of c* uniform, coherent and thin membranes are produced. More preferably, the concentration of the copolymer is between about seventy-five percent (75%) and one hundred fifty percent (150%) of c*. The product of the addition of the above described non-solvent and poor solvent components can be best described as stable polymer colloids. Generally, the polymer phase inversion is carried out by the controlled addition of a specific amount of a non-solvent, for example, where a partial exchange of solvent and non-solvent with the confines of the polymer chains takes place. The amount of non-solvent may range from about 1% to about 50%, preferably from about 5% to about 30%. The specific concentration of nonsolvent or poor solvent is dependent on the polymer concentration, polymer molecular weight, and polymer composition. The partially coagulated polymer chains form associated clusters or multi-chain aggregates which can readily be placed onto a ceramic substrate. The polymer chain aggregates subsequently form a coherent layer on the substrate surface. This process can be used to coat a wide variety of ceramic monolith surface structures including alumina, silica, titania, ceramic surfaces and the like. It should be also noted that the porosity and pore size of the ceramic support can be widely varied. These membranes can be used in numerous applications where efficient and effective separation of aromatics and aliphatics are required, e.g., on-board separation of fuels in automobiles and trucks, refinery and other downstream operations, upstream applications, chemical operations and the like.

The membrane coating is dried and dried at temperatures ranging from about 25° C. to about 300° C., for a period ranging from about 1 hour to about 24 hours. The resulting film generally ranges from about 0.01 microns to about 10 microns. To help insure that the membrane is “pin hole free” the membrane deposition process may be repeated. A simple vacuum/pressure test, as illustrated in the following examples, may be used to confirm the membrane integrity. The resulting polymeric membrane is preferably a copolymer having a multi-block structure of imide-based hard segments interspersed with soft segments comprising an aliphatic polyester.

The examples presented below exemplify the subject matter for this invention.

### EXAMPLE 1

Diepoxide crosslinked/esterified polyimide-aliphatic polyester copolymers have been synthesized from an oligomeric aliphatic polyester diol, an anhydride, a diamine, and a diepoxide or mixtures thereof. This example is a diepoxyoctane crosslinked/esterified polyimide-polyadipate copolymer (diepoxyoctane polyethylene imide, [PEI]) membrane is used as an example. In the synthesis, 5 g (0.005 moles) of a 1000 g/mole polyethylene adipate diol (PEA) is reacted with 2.18 g (0.01 moles) of pyromellitic dianhydride (PMDA) to make a prepolymer in the end-capping step (reaction conditions: 165° C./6.5 hours). 25 g of dimethylformamide (DMF) is subsequently added. The temperature is decreased to 70° C. The prepolymer is dissolved in a suitable solvent such as dimethylformamide. 1.34 g (0.005 moles) of 4,4′ methylenebis(2-chloroaniline) (MOCA) is subsequently added (dissolved in 5 g DMF). In the DMF solution, one mole of the prepolymer reacts with one mole of MOCA to make a copolymer containing polyamic acid hard segment and PEA soft segment in the chain-extension step. An additional 91.0 g of DMF is added. Subsequently, 121.0 g acetone is added to prevent gelling. The solution is stirred for 1.5 hours (70° C.). The solution is now cooled to room temperature under continual stirring conditions. 1,2,7,8-diepoxyoctane (designated DENO) (1.42 g-0.01 moles) is subsequently added to the copolymer-DMF solution at a diepoxide/PEA molar ratio of 2. At this point the copolymer concentration is 4.0 wt %. A portion of the above synthesized copolymer solution was diluted with equal amounts of dimethylformamide and acetone (50/50 by weight) to reduce the copolymer concentration to 2.0 wt %. The diluted solution was vigorously stirred at room temperature to insure solution consistency and uniformity.

In the synthesis with PEA, PMDA, MOCA and diepoxide at a molar ratio of 1/2/1/2, the cross-linking reaction occurs among pendent carboxylic acid groups adjacent to the ester linkages located between polyimide hard segments and polyester soft segments. The degree of cross-linking can be varied by controlling the concentration of diepoxide incorporated into the multi-block structure. In addition, the “soft” segment denoted as PEA (1000 g/mole) can be easily replaced with PEA (2000 or 3000 g/mole), for example.

Membrane formation is accomplished by solution coating [e.g., passing the solution directly into the channels of the ceramic monolith or dip coating or using a vacuum to draw the polymer solution (i.e., polymer solution contains both a good solvent as well as a non-solvent or poor solvent or combination thereof) into the porous, inorganic substrate] onto a porous inorganic tubular support (e.g., porous silica, porous titania or porous alumina). Subsequently, a relatively low concentration solution of the polyamic acid without a non-solvent or poor solvent present is passed into the channels. Membrane thickness is adjusted by changing the polymer concentration, solution rheology, as well as the number of times the polyamic acid solution is passed through the channels. In addition it should be noted that the non-solvent contains the appropriate amount of chemical cross-linker to ensure that the amount of cross-linking within the membrane remains at the target value. The membrane is initially dried at a suitable temperature (e.g., room temperature) to remove substantially all of the solvent (i.e., solvent evaporation), and curing occurs (i.e., chemical cross-linking/imidization reaction conditions: 150° C. for about 8 hours) with the reaction of diepoxide with pendent carboxylic acid groups. In the initial drying step, DMF was evaporated from the membrane in a box purged with nitrogen gas at room temperature for approximately 12 hours. The membrane is comprised of a cross-linked/esterified polyimide-polyadipate copolymer. The curing step converts the polyamide ester hard segment to the polyimide hard segment via the imide ring closure.

### EXAMPLE 2

In this example, the porous, inorganic substrate is a ceramic monolith having a titania topcoat. A 0.01 micron pore size silica monolith produced by CeraMem Corp. (Waltham, Mass.)—designated Model LM-001-T (Serial number AG 1345) is used in this example. The membrane forming procedure consisted of filling the inside of the monolith via gravity feed with a 2 wt % PEI copolymer solution with 1-butanol used as the non-solvent. The non-solvent allows the polymer chains to aggregrate into larger swollen colloidal entities. These colloidal structures remain in solution forming what is visually described as a fluid containing a white suspension. The initial polymer solution was completely transparent.

### EXAMPLE 3

The inorganic silica monolith support described in Example 2 was coated according to the following procedure.

A ceramic monolith substrate was about one, 1 foot long×1 inch diameter, having 0.1 micron porosity alumina coated nominal 2 mm square channels, was coated with a dilute solution of PEI polymer precursor. The weight of the starting monolith was 303.9 g. 30 g of the 2 wt % PEI solution was combined with 150 g of 1-butanol to produce a milky white suspension. 175 g of the suspension was poured into a feed vessel. The feed vessel is at 205 mls solution volume. 20 KPa back pressure with nitrogen gas was applied to prevent solution/suspension from penetrating the monolith while loading in the suspension. The monolith was filled via a gravity feed system. Upon complete filling of the monolith the feed vessel was at 85 mls solution volume. Subsequently, the back pressure was released and the back side vacuum applied. Vacuum pressure was increased at 10 KPa at a time. Solution did not come through the monolith to the vacuum trap until the vacuum was at 87 KPa. The filtrate retained in the vacuum trap was clear. The amount of filtrate recovered was 13.5 g. The vacuum was released and monolith drained. The total amount of solution/suspension recovered from the monolith and combined with the remaining feed solution was 145 mls. Unrecovered or used solution was 60 mls. The monolith was removed from the housing. The monolith was now allowed to dry by being held in a vertical position with nitrogen gas flowing through each channel overnight. Weight of the dried monolith was 304.11 g. The monolith was further dried at 100° C. for 1 hour and then cured at 150° C. for 2 hours. The monolith weight after curing was about 304.06 g. The total weight of polymer on the monolith was about 0.1 g. A vacuum drop test was performed—a vacuum of 85 KPa dropped to 10 KPa over a period of 3 minutes.

The coating solution in this part of the membrane preparation was the same as described above (without the addition of a non-solvent) except that the polymer concentration was decreased to 1 wt % using a equal amounts of acetone and dimethylformamide by weight. The total weight of the 1 wt % polymer solution poured into the feed vessel was 180 g. Subsequently, the monolith channels were filled via a gravity feed system. A vacuum was pulled on the backside of the monolith. It is noteworthy that no solution went through the monolith and captured in the vacuum trap. The monolith was now drained with the weight of the recovered solution was 173 g. The monolith was again removed from the housing and dried by having nitrogen gas blown through all of the channels. The weight of the monolith at this particular point was 304.08 g. Upon further drying (120° C. for 1 hour) and curing (150° C. for 4 hours) the monolith weighted 304.03 g, which amounted to a polymer deposition of about 0.07 g. Again a vacuum drop test was performed—85 KPa vacuum to 80 KPa vacuum over a period of 22 minutes. Upon evaluation the coated monolith had high flux and only moderate selectivity using gasoline as the feed. The monolith was now prepared for a third coating procedure.

Prior to coating the gasoline was purged from the monolith. A 50/50 mixture of acetone and dimethylformamide was used to clean the monolith. The monolith was filled with the solution mixture and drained. This process was repeated three times. The monolith was again dried via blowing nitrogen gas through all of the channels.

The monolith was coated in the manner described above using the PEI solution without the 1-butanol. The initial solution (1 wt %) weighed 153 g. No solution was observed to come through the monolith to the vacuum trap. However, a small amount was pulled through the overflow tube. The solution was again drained from the monolith and with the unused solution amounted to 143 g implying that about 10 g of solution was retained in the monolith structure. The monolith was now dried for 2.5 hours. The weight at this point was 304.12 g. The monolith was cured overnight at 150° C. under a nitrogen gas blanket. The final weight of the coated monolith was 304.12 g. The vacuum drop test from 85 to 75 KPa was 30 minutes.

### EXAMPLE 4

A portion of the 2% co-polymer solution prepared by Example 1 was added to a non-solvent, 1-Butanol, in ratio of 1:5 by weight (30 g/150 g), and shaken vigorously. A white colloidal suspension resulted. The initial co-polymer solution was completely transparent.

A CeraMem (Waltham, Mass.) porous, inorganic ceramic monolith 0.13 m2 test element ˜12″ long×1″ diameter, designated Model LM-001-T (Serial Number AH1345), consisting of a 0.01 micron porosity titania washcoat on a porous silicon carbide monolith substrate having ˜60×1.6 mm square channels, was slip-coated with the co-polymer suspension in 1-Butanol, followed by re-coating with the original co-polymer solution in DMF/acetone, drying at 120° C. and curing at 150° C. for 4 hours.

The cured, cross-linked PEI(PEA1000/DENO) coated TiO2 monolith, designated NB#25016-46-1, having a final polymer weight of 0.07 g was tested for membrane integrity by a vacuum drop test. The initial vacuum of 85 kPa decreased to 80 kPa in 22 minutes, demonstrating excellent integrity of the polymer film. Estimated thickness of the polymer film based on 0.07 g polymer, 1.3 g/cc density, and 0.11 m2 surface area corresponds to 0.49 microns.

### EXAMPLE 5

Membrane element NB#25016-46-1 prepared as described in Example 4, was installed in a test unit for evaluation using gasoline feed under pervaporation conditions. The element was installed in a 13″×1.5″ OD housing with CeraMem designed Viton O-ring internal seals and Sanitary-type flanges with Viton gaskets. A ⅜″ Swagelok fitting was welded to the housing about 1.5″ from one end to take permeate. The inlet contained a Bete WL-1/4-90° nozzle located ˜1″ from the membrane element face. The membrane housing was operated vertically in down-flow from inlet to outlet with the permeate taken at the lowest point.

Gasoline feed rate was controlled by means of a Brooks Quantim Mass Flow Controller supplied by a recirculating pump operated at 400 kPag. Gasoline heating was provided by means of a water/steam filled heat pipe having an internal co-axial gasoline heat exchanger operated vertically providing the desired fuel temperatures. No preheating of the feed by product was used in the experiment. Products were cooled by heat exchange against 10° C. glycol. Feed pressure was maintained by means of a Tescom back-pressure regulator operating on the cooled retentate stream. Permeate vacuum was obtained by means of a Fox 0.030″ Mini-eductor using circulating cooled permeate as the motive fluid at 450 kPag.

An initial vacuum test in the test unit confirmed membrane integrity. A pressure of 17.3 kpa(abs) was obtained by evacuating the permeate side of the monolith housing and isolating with the feed side at ambient pressure in air. The pressure increased 3 kPa(abs) to 20.3 kpa(abs) in 10 minutes, confirming the polymer membrane integrity.

Initial test conditions were established to obtain approximately 20% permeate yield on a 90.3 RON gasoline feed of 0.7253 g/cc density at 20° C. and containing ˜32 wt % aromatics. A feed rate of 1.0 g/s was established with an outlet pressure of 200 kpag and the gasoline heated to 152° C. Partial vaporization of the feed occurred corresponding to ˜87% vapor/liquid ratio by weight at an inlet pressure of 277 kpag upstream of the flow distribution nozzle.

After two hours operation, samples of permeate and retentate were taken. A permeate rate of 0.21 g/s was obtained with retentate rate of 0.80 g/s for a total 1.01 g/s. The permeate density was 0.7881 g/cc indicting a substantial increase in aromatic content and corresponding to an octane number of 98.8 RON. The retentate density was 0.7209 corresponding to an octane number of 89.7 by a RON vs density correlation established from experimental data.

These results demonstrate the effectiveness of the coating technique described in Example 4 to prepare ultra-thin polymer membranes suitable for separation of hydrocarbon feeds by pervaporation.

After several days of operation at various process conditions, the performance of the membrane element was determined at the original conditions: gasoline feed at 1.0 g/s, feed temperature 151.8° C., inlet pressure 268 kpag, outlet pressure 200 kpag, permeate pressure 21 kPa(abs). Permeate flux had increased to 0.34 g/s and retentate rate decreased to 0.69 g/s for total of 1.03 g/s. Permeate density decreased to 0.7698 g/cc, while retentate density was nearly same at 0.7198 g/cc.

### EXAMPLE 6

Recoating of the used NB#25016-46-1 membrane, after washing the channels three times with 50/50 DMF/acetone at room temperature, was achieved by a single slip-coating with vacuum using a 1% solution of the co-polymer/diepoxide solution described in Example 1. The added polymer was cured at 150° C. overnight. Polymer weight added was indeterminate.

Vacuum testing of the recoated membrane confirmed excellent integrity with only 1.9 kPa pressure increase from 13.1 kPa(abs) after 10 minutes isolation of the permeate side and ambient air pressure on feed channel side.

Subsequent testing at conditions similar to those used in Example 5 demonstrated both improved membrane stability and selectivity. Two hours after startup, with gasoline feed at 1.0 g/s, feed temperature 157.1° C., inlet pressure 282.3 kpag, outlet pressure 200 kpag, permeate pressure 19 kPa(abs), the permeate flux was 0.20 g/s and retentate rate 0.83 g/s for a total of 1.03 g/s. Permeate density increased to 0.7881 g/cc, while retentate density was 0.7147 g/cc, both similar to initial results.

After 6 additional days of nearly continuous operation, a rate check confirmed the stability of the recoated membrane. A permeate rate of 0.20 g/s with density of 0.7914 g/cc and a retentate rate of 0.80 g/cc with 0.7172 density were obtained with gasoline feed at 1.0 g/s, feed temperature 154° C., inlet pressure 295 kPag, outlet pressure 200 kPag, permeate pressure 16 kPa(abs).

### EXAMPLE 7

The coating procedure of Example 4 was modified to increase the concentration of diepoxide-n-octane in the initial 1-butanol emulsion coatings by 5 times to obtain the equivalent diepoxide to co-polymer ratio of the original solution from Example 1.

A porous, inorganic ceramic monolith 0.13 m2 test element ˜12″ long×1″ diameter, designated Model LM-001-T (Serial Number AH-1542), consisting of a 0.01 micron porosity titania washcoat on a porous silicon carbide monolith substrate having ˜60×1.6 mm square channels, was slip-coated with the modified co-polymer suspension in 1-Butanol, followed by re-coating with the original co-polymer solution in DMF/acetone, drying at 120° C. and curing at 150° C. for 4 hours.

The cured, cross-linked PEI(PEA1000/DENO) coated TiO2 monolith having a final polymer weight of 0.08 g was tested for integrity by a vacuum drop test. The initial vacuum of 85 kPa decreased to 50 kPa in 64 minutes, demonstrating excellent integrity of the polymer film. Estimated thickness of the polymer film based on 0.08 g polymer, 1.3 g/cc density, and 0.11 m2 surface area corresponds to 0.56 microns.

### EXAMPLE 8

Membrane element NB#25016-64-1 was tested as described in Example 5. A vacuum test in the process unit confirmed the integrity of the polymer film and seals with vacuum drop from 85 kPa to 50 kPa in 64 minutes.

Initial test results indicated high flux rates. A permeate rate of 0.21 g/s with density 0.7337 g/cc was obtained at 1 hour on stream with feed gasoline at 1.0 g/s, 108° C., 234.6 kpag inlet pressure, 210 kPag outlet pressure and 58.1 kpa(abs) permeate pressure. Inlet conditions corresponded to 28% vapor/liquid ratio by weight.

The gasoline heat exchanger was modified from co-axial to coaxial with internal spiral (Inconel 600) prior to this run.

The feed was changed to a surrogate gasoline blend for an extended run at a reduced total feed rate of 0.5 g/s, including recycle of permeate. The net permeate rate was maintained at 0.075 g/s. Conditions were maintained at 157° C., 226 kPag inlet pressure, 205 kpag outlet pressure and 28 kPa permeate pressure. The permeate eductor inlet pressure was maintained at 480 kpag. Feed pressure to MFC was maintained at 410 kPag.

After processing nearly an entire 55 gallon drum of gasoline, net permeate quality remained excellent with a density of 0.7966 g/cc corresponding to 99.6 RON (conservatively by density correlation) at a net yield on fresh feed of 20.8%. Material balance results indicated a total permeate rate of 0.241 g/s, with 0.173 g permeate recycle, 0.068 g/s net permeate, and a fresh feed rate of 0.327 g/s.

In this example, a total of ˜146 kg of gasoline was processed over a polymer membrane film of only 0.08 g or 1.8 million grams of feed per gram of polymer used. These results clearly demonstrate the stability and selectivity of the ultra-thin membrane films of the invention.

What is claimed is:

1. A process for making an ultra-thin polymeric membrane comprising:
a. providing a porous substrate, and
b. preparing a colloidal solution of an associating polymer at a polymer concentration of about c* and including an amount of non-solvent, and
c. coating the porous substrate with the solution of step b, and
d. drying the coated substrate to form a ultra thin polymeric membrane.

2. The process of claim 1 wherein the colloidal solution has a concentration of associating polymer of about c* and an amount of non-solvent ranging from about 1% to about 50%.

3. The process of claim 2 wherein the associating polymer is a polyamic acid copolymer.

4. The process of claim 3 where the polyamic acid copolymer is a diepoxide cross-linked polyimide-aliphatic polyester copolymer.

5. The process of claim 4 wherein the copolymer is synthesized from an oligomeric aliphatic polyester diol, an anhydride, a diamine, and a diepoxide, or mixtures thereof.

6. The process of claim 5 wherein the copolymer comprises a diepoxyoctane polyethylene imide.

7. The process of claim 4 wherein concentration of the diepoxide is selected to produce a polymer membrane having polyimide hard segments and polyester soft segments.

8. The process of claim 7 wherein the concentration of diepoxide is selectively varied to produce a polymer membrane having polyimide hard segments that comprise from about 10 vol % to about 90% of the membrane.

9. The process of claim 8 wherein the polyimide hard segments comprise from about 40 vol % to about 50 vol % of the membrane.

10. The process of claim 1 wherein the porous substrate in an inorganic material.

11. The process of claim 10 wherein the porous substrate is a ceramic porous material.

12. The process of claim 1 wherein the coating of step (c) comprises
a. dip coating the porous substrate with the colloidal solution, and
b. applying a vacuum to at least a portion of the porous substrate.

13. The process of claim 12 wherein step (a) further comprises applying a ultrasonic signal to the dip coating.

14. The process of claim 1 wherein the drying and drying step (d) comprises heating the coated substrate to a temperature ranging from about 25° C. to about 300° C. for a time period ranging from about 1 hours to about 24 hours.

15. The process of claim 1 wherein the coating step (c) is repeated after step (d).

16. The process of claim 1 wherein the membrane ranges in thickness from about 0.01 microns to about 10 microns.
